(19) United States
(12) Patent Application Publication
(10) Pub. No.: US 2026/0032391 A1
(43) Pub. Date: Jan. 29, 2026

(54) MEMS LOUDSPEAKER

(71) Applicant: AAC Kaitai Technologies (Wuhan) CO., LTD., Wuhan (CN)

(72) Inventors: Linxin Zhang, Wuhan (CN); Qiang Dan, Wuhan (CN); Yufen Chu, Wuhan (CN); Yao Hui, Wuhan (CN); Yang Li, Wuhan (CN)

(21) Appl. No.: 18/984,868

(22) Filed: Dec. 17, 2024

Related U.S. Application Data
(63) Continuation of application No. PCT/CN2024/107621, filed on Jul. 25, 2024.

(51) Int. Cl. H04R 7/26; H04R 7/04; H04R 7/18

(52) U.S. Cl. CPC H04R 7/26; H04R 7/04; H04R 7/18; H04R 2201/003

(57) ABSTRACT

The present invention discloses a micro-electromechanical system (MEMS) loudspeaker, which includes a supporting structure, a diaphragm and a barrier plate. The supporting structure includes a supporting body and a sound hole penetrating from one end of the supporting body to the other end. The diaphragm is fixed on an inner circumferential side of the supporting body and located in the sound hole. The diaphragm is configured to vibrate and generate amplitude-modulated ultrasonic waves. The barrier plate is covered and fixed to one end of the supporting body. Due to the distance between the barrier plate and the diaphragm, the amplitude-modulated ultrasonic waves are demodulated to obtain modulated sound waves. Thereby improving the sound wave demodulation efficiency and amplitude of the MEMS loudspeaker and further improving the acoustic performance of the MEMS loudspeaker.

### CROSS-REFERENCE TO RELATED APPLICATIONS

This application is a continuation of International Application No. PCT/CN2024/107621, filed on Jul. 25, 2024, the entire content of which is incorporated herein by reference.

### TECHNICAL FIELD

The present invention relates to the technical field of acoustics, and in particular, to a micro-electromechanical system (MEMS) loudspeaker.

### BACKGROUND

Loudspeaker is a transducer device that converts an electrical signal into a sound signal. Loudspeakers are widely used in portable mobile electronic products, such as a mobile phone and a tablet, to convert audio signals into sound for playing. Due to the miniaturization of the portable mobile electronic products, minimization of the loudspeakers become increasingly widespread. A sound pressure level (SPL) and total harmonic distortion (THD) of a loudspeaker are important indicators of acoustic performance.

The loudspeaker of the related technology includes a supporting structure, a diaphragm that is fixed in the supporting structure and is configured to send symmetrical ultrasonic waves, and a baffle plate that is spaced apart from one side of the supporting structure away from an ultrasonic vibration sound production unit. A through hole is formed in a penetrating manner in one side of the supporting structure close to the baffle, and a narrow gap is formed between the baffle plate and a supporting member. The narrow gap is communicated to the through hole. The narrow gap has strong nonlinearity, and symmetrical ultrasonic waves passing through the gap may be distorted, thereby demodulating audible sound. However, the diaphragm has low efficiency for demodulating the audible sound through the narrow gap, low amplitude, and poor acoustic performance.

Therefore, it is necessary to provide an MEMS loudspeaker to solve the above technical problems.

### SUMMARY

The present invention aims to provide an MEMS loudspeaker that has high sound wave demodulation efficiency, good amplitude enhancing effect, and good acoustic performance.

In order to achieve the above object, in a first aspect, the present invention discloses a micro-electromechanical system (MEMS) loudspeaker, which includes a supporting structure, a diaphragm and a barrier plate.

The supporting structure includes a supporting body and a sound hole penetrating from one end of the supporting body to the other end.

The diaphragm is fixed on an inner circumferential side of the supporting body and located in the sound hole. The diaphragm is configured to vibrate and generate amplitude-modulated ultrasonic waves.

The barrier plate is covered and fixed to one end of the supporting body; a distance between the barrier plate and the diaphragm is less than a maximum distance of vibration displacement of the diaphragm in a direction away from the barrier plate. Due to the distance between the barrier plate and the diaphragm, the amplitude-modulated ultrasonic waves are demodulated to obtain modulated sound waves.

As an improvement, a plurality of damping holes penetrating through the diaphragm and/or the barrier plate are provided in the diaphragm and/or the barrier plate in a spacing manner in a vibration direction of the diaphragm.

As an improvement, a plurality of damping holes penetrating through the diaphragm and the barrier plate are respectively provided in the diaphragm and the barrier plate; the plurality of damping holes are uniformly provided in the diaphragm; and the plurality of damping holes are uniformly provided in the barrier plate.

As an improvement, at least a portion of the damping holes in the diaphragm and at least a portion of the damping holes in the barrier plate are staggered from each other.

As an improvement, the barrier plate resists against the diaphragm.

As an improvement, the barrier plate is spaced apart from the diaphragm.

As an improvement, the barrier plate includes a barrier plate body covered and fixed to one end of the supporting body and spaced apart from the diaphragm, and a plurality of protruding portions formed by protruding and extending out of one side of the barrier plate body close to the diaphragm; the plurality of protruding portions are spaced apart; and a distance between the protruding portions and the diaphragm is less than the maximum distance of the vibration displacement of the diaphragm in the direction away from the barrier plate.

As an improvement, due to the distance between the barrier plate and the diaphragm, the barrier plate blocks an amplitude of vibration displacement of the diaphragm in a direction towards the barrier plate, so that the symmetric amplitude-modulated ultrasonic waves become asymmetric sound waves; and the asymmetric sound waves include the modulated sound waves.

As an improvement, a driving mode for the diaphragm is any one of piezoelectric driving, electrostatic driving, and electromagnetic driving.

As an improvement, the barrier plate is any one of a monocrystalline silicon barrier plate, a metal barrier plate, a polymer plate, and a multi-layer composite material barrier plate.

Compared with the prior art, According to the MEMS loudspeaker of the present invention, the distance between the barrier plate and the diaphragm is less than the maximum distance of the vibration displacement of the diaphragm in the direction away from the barrier plate; and due to the distance between the barrier plate and the diaphragm, the amplitude-modulated ultrasonic waves can be demodulated to obtain the modulated sound waves, thereby improving the sound wave demodulation efficiency and amplitude of the MEMS loudspeaker and further improving the acoustic performance of the MEMS loudspeaker.

### BRIEF DESCRIPTION OF THE DRAWINGS

In order to explain the technical solutions of the embodiments of the present invention more clearly, the following will briefly introduce the accompanying drawings used in the embodiments. Apparently, the drawings in the following description are only some embodiments of the present invention. Those of ordinary skill in the art can obtain other drawings based on these drawings without creative work.

FIG. 1 is a first schematic structural diagram of an MEMS loudspeaker according to an embodiment of the present invention;

FIG. 2 is a second schematic structural diagram of an MEMS loudspeaker according to an embodiment of the present invention;

FIG. 3 is a third schematic structural diagram of an MEMS loudspeaker according to an embodiment of the present invention;

FIG. 4 is a fourth schematic structural diagram of an MEMS loudspeaker according to an embodiment of the present invention;

FIG. 5 is a fifth schematic structural diagram of an MEMS loudspeaker according to an embodiment of the present invention;

FIG. 6 is a sixth schematic structural diagram of an MEMS loudspeaker according to an embodiment of the present invention;

FIG. 7 is a seventh schematic structural diagram of an MEMS loudspeaker according to an embodiment of the present invention;

FIG. 8 is an eighth schematic structural diagram of an MEMS loudspeaker according to an embodiment of the present invention;

FIG. 9 is a ninth schematic structural diagram of an MEMS loudspeaker according to an embodiment of the present invention;

FIG. 10 is a tenth schematic structural diagram of an MEMS loudspeaker according to an embodiment of the present invention;

FIG. 11 is an eleventh schematic structural diagram of an MEMS loudspeaker according to an embodiment of the present invention;

FIG. 12 is a twelfth schematic structural diagram of an MEMS loudspeaker according to an embodiment of the present invention;

FIG. 13 is a diagram of a displacement response of a nonlinear resonator in an MEMS loudspeaker to an input signal according to an embodiment of the present invention;

FIG. 14 is a spectrogram of a frequency of audible sound of an MEMS loudspeaker to an input signal according to an embodiment of the present invention; and

FIG. 15 is a schematic diagram of displacement of a nonlinear resonator in an MEMS loudspeaker according to an embodiment of the present invention.

In the drawings, 100: MEMS loudspeaker; 1: supporting structure; 11: supporting body; 12: sound hole; 2: diaphragm; 3: barrier plate; 31: barrier plate body; 32: protruding portion; and 4: damping hole.

### DETAILED DESCRIPTION OF THE EMBODIMENTS

The technical solutions in the embodiments of the present invention will be clearly and completely described below in conjunction with the accompanying drawings in the embodiments of the present invention. Apparently, the described embodiments are only a part of the embodiments of the present invention, rather than all the embodiments. Based on the embodiments in the present invention, all other embodiments obtained by those ordinarily skilled in the art without doing creative work shall fall within the protection scope of the present invention.

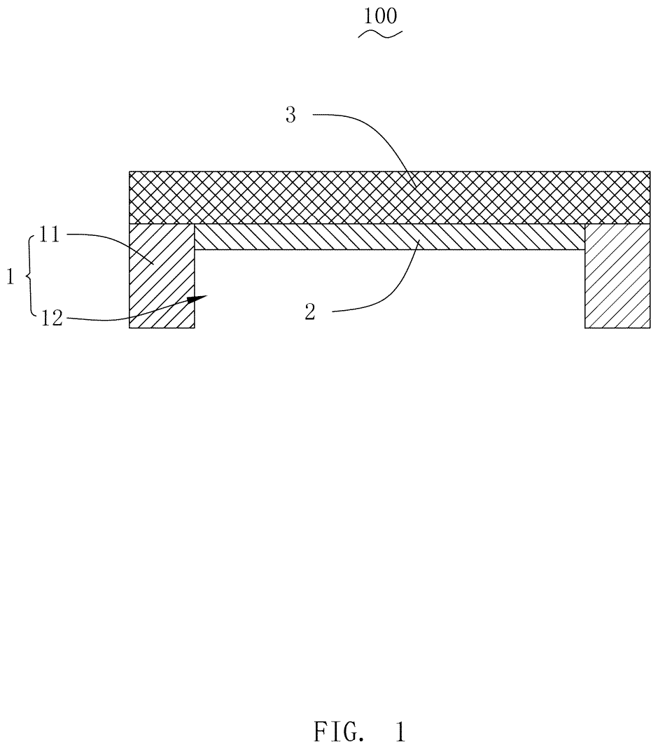

The present invention provides an MEMS loudspeaker 100, as shown in FIG. 1 to FIG. 12, including a supporting structure 1, a diaphragm 2, and a barrier plate 3.

The supporting structure 1 includes a supporting body 11 and a sound hole 12 penetrating from one end of the supporting body 11 to the other end. The diaphragm 2 is fixed on an inner circumferential side of the supporting body 11 and located in the sound hole 12. The diaphragm 2 is configured to vibrate and generate amplitude-modulated ultrasonic waves. The barrier plate 3 is covered and fixed to one end of the supporting body 11. A distance between the barrier plate 3 and the diaphragm 2 is less than a maximum distance of vibration displacement of the diaphragm 2 in a direction away from the barrier plate 3. Due to the distance between the barrier plate 3 and the diaphragm 2, the amplitude-modulated ultrasonic waves are demodulated to obtain modulated sound waves.

The diaphragm 2 is further provided with an attachment structure, such as an electrode.

Specifically, due to the distance between the barrier plate 3 and the diaphragm 2, the barrier plate 3 blocks an amplitude of vibration displacement of the diaphragm 2 in a direction towards the barrier plate 3, so that the symmetric amplitude-modulated ultrasonic waves become asymmetric sound waves; and the asymmetric sound waves include the modulated sound waves.

Specifically, a driving mode for the diaphragm 2 is any one of piezoelectric driving, electrostatic driving, and electromagnetic driving. Of course, according to an actual need, other driving modes can be used for the diaphragm 2. The MEMS loudspeaker 100 not only includes a supporting structure 1, the diaphragm 2, and the barrier plate 3, but also includes a driving structure configured to drive the diaphragm 2 to vibrate and produce sound.

Specifically, the barrier plate 3 is any one of a monocrystalline silicon barrier plate, a metal barrier plate, a polymer plate, and a multi-layer composite material barrier plate. Of course, according to an actual need, other materials can also be used to form the barrier plate 3.

In a first optional embodiment for arranging the diaphragm 2 and the barrier plate 3, as shown in FIG. 1 to FIG. 4, the barrier plate 3 resists against the diaphragm 2.

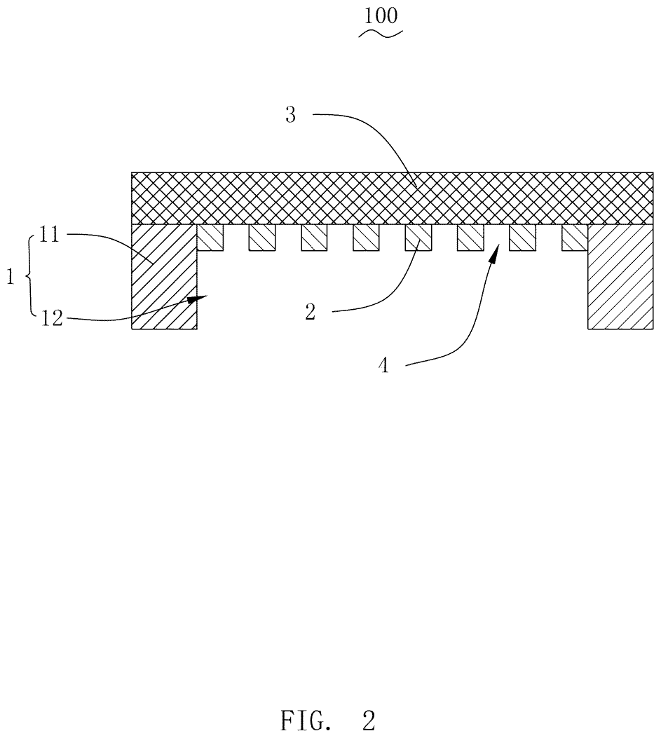

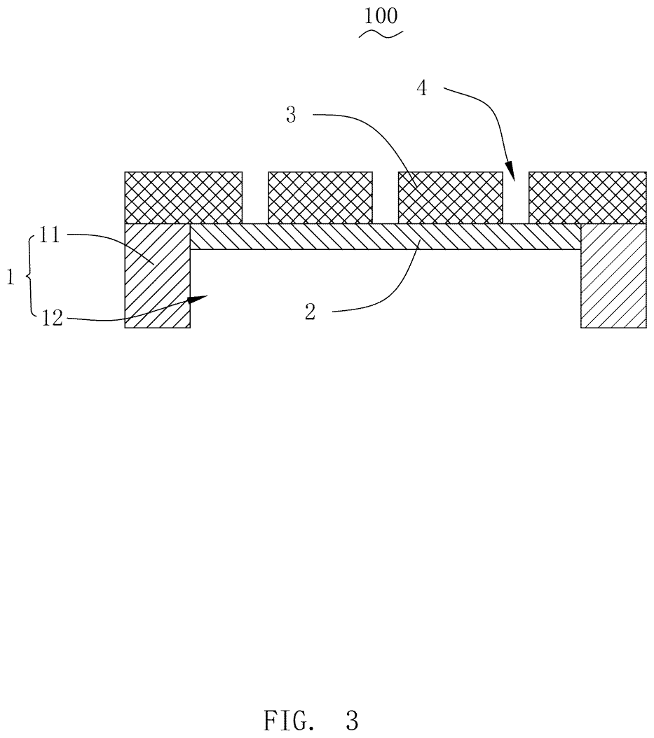

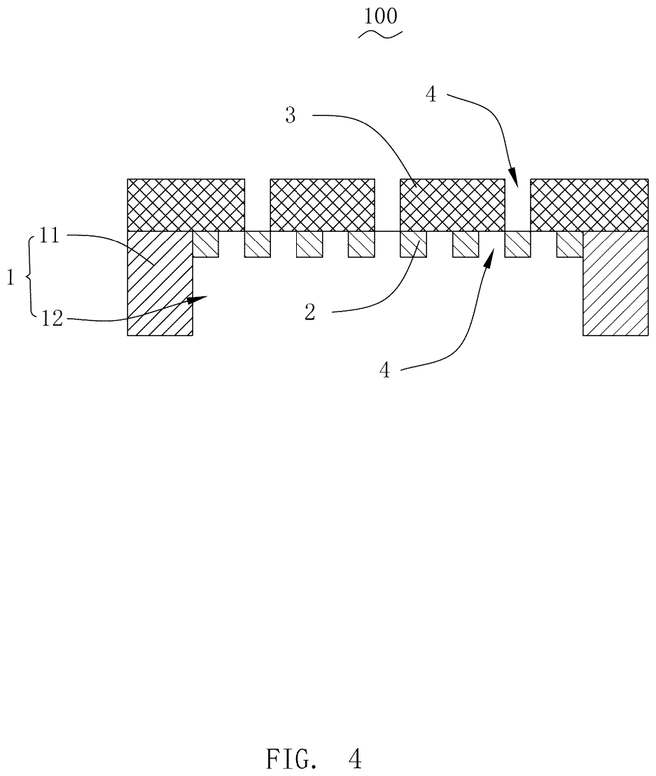

Based on this embodiment, to reduce the damping of the diaphragm 2 and enhance its vibration displacement effect, as shown in FIG. 2, in a first mode, a plurality of damping holes 4 penetrating through the diaphragm 2 are provided in the diaphragm 2 in a spacing manner in a vibration direction of the diaphragm 2. As shown in FIG. 3, in a second mode, a plurality of damping holes 4 penetrating through the diaphragm are provided in the barrier plate 3 in a spacing manner in a vibration direction of the diaphragm 2. As shown in FIG. 4, in a third mode, a plurality of damping holes 4 penetrating through the diaphragm 2 and the barrier plate 3 are respectively provided in the diaphragm 2 and the barrier plate 3 in a spacing manner in a vibration direction of the diaphragm 2.

The plurality of damping holes 4 are uniformly provided in the diaphragm 2; and the plurality of damping holes 4 are uniformly provided in the barrier plate 3. Of course, according to an actual need, the plurality of damping holes 4 in the diaphragm 2 can also be non-uniformly arranged, and the plurality of damping holes 4 in the barrier plate 3 can also be non-uniformly arranged.

At least a portion of the damping holes 4 in the diaphragm 2 and at least a portion of the damping holes 4 in the barrier plate 3 are staggered from each other.

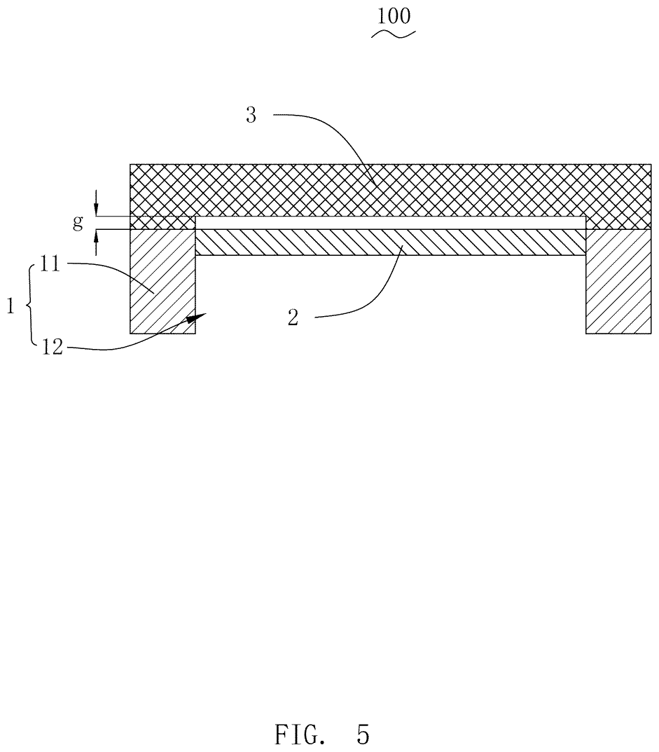

In a second optional embodiment for arranging the diaphragm 2 and the barrier plate 3, as shown in FIG. 5 to FIG. 8, the barrier plate 3 and the diaphragm 2 are spaced apart from each other.

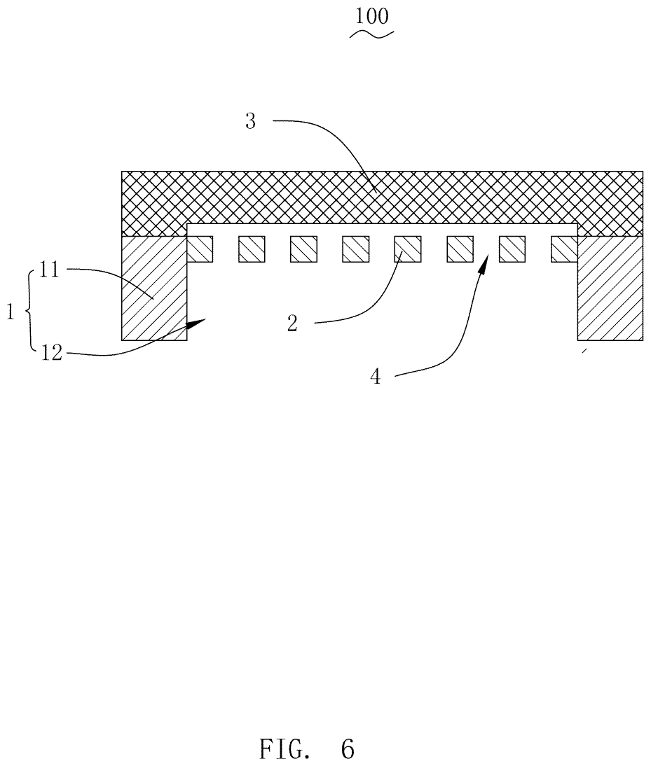

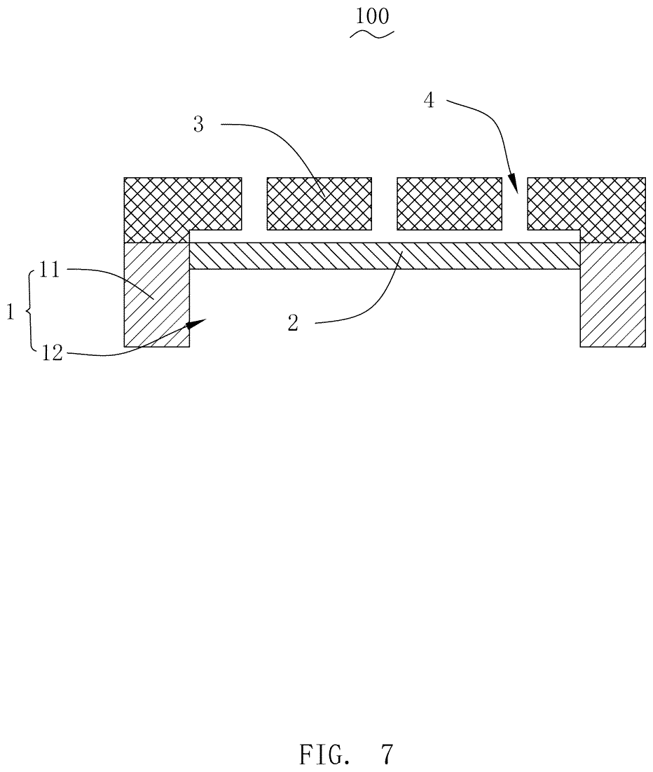

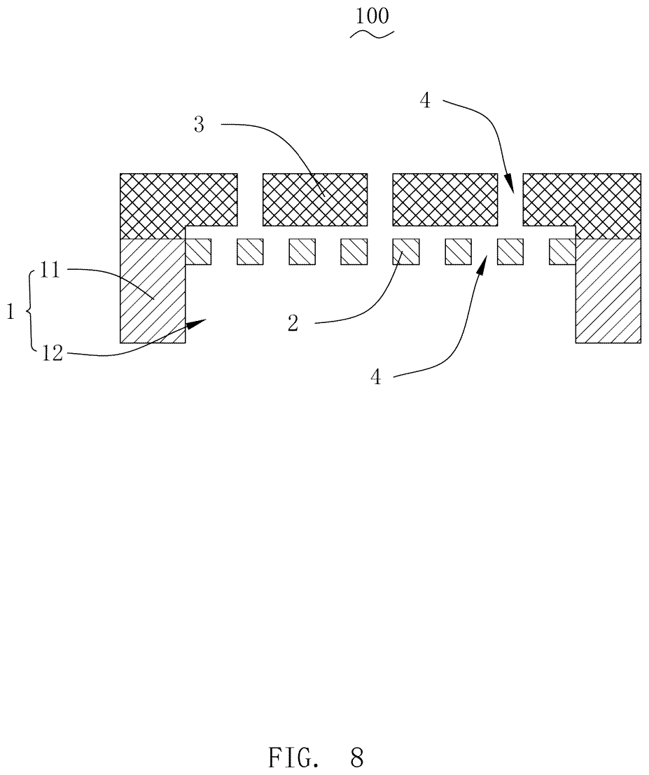

Based on this embodiment, to reduce the damping of the diaphragm 2 and enhance its vibration displacement effect, as shown in FIG. 6, in a first mode, a plurality of damping holes 4 penetrating through the diaphragm 2 are provided in the diaphragm 2 in a spacing manner in a vibration direction of the diaphragm 2. As shown in FIG. 7, in a second mode, a plurality of damping holes 4 penetrating through the diaphragm are provided in the barrier plate 3 in a spacing manner in a vibration direction of the diaphragm 2. As shown in FIG. 8, in a third mode, a plurality of damping holes 4 penetrating through the diaphragm 2 and the barrier plate 3 are respectively provided in the diaphragm 2 and the barrier plate 3 in a spacing manner in a vibration direction of the diaphragm 2.

The plurality of damping holes 4 are uniformly provided in the diaphragm 2; and the plurality of damping holes 4 are uniformly provided in the barrier plate 3. Of course, according to an actual need, the plurality of damping holes 4 in the diaphragm 2 can also be non-uniformly arranged, and the plurality of damping holes 4 in the barrier plate 3 can also be non-uniformly arranged.

At least a portion of the damping holes 4 in the diaphragm 2 and at least a portion of the damping holes 4 in the barrier plate 3 are staggered from each other.

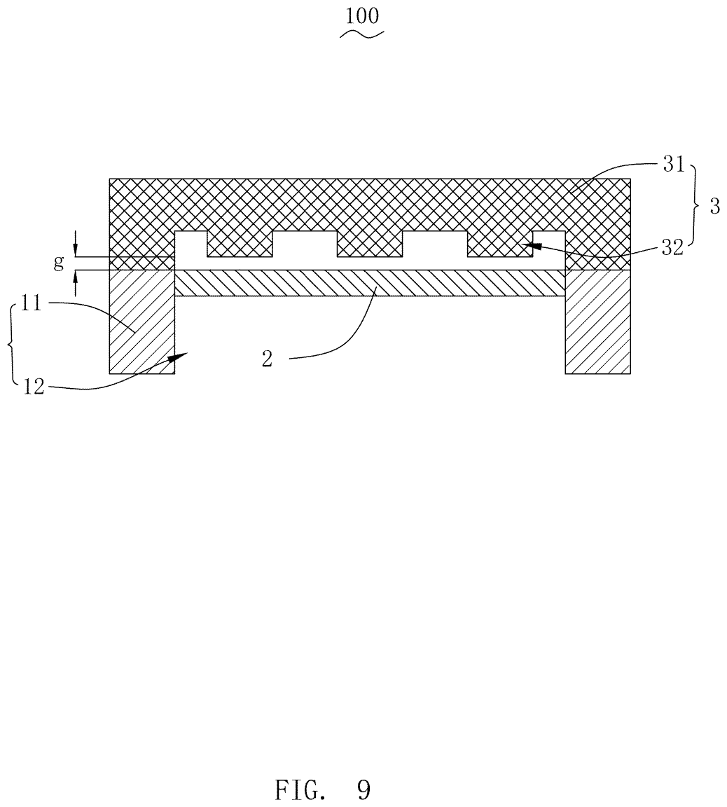

In a third optional embodiment for arranging the diaphragm 2 and the barrier plate 3, as shown in FIG. 9 to FIG. 12, the barrier plate 3 includes a barrier plate body 31 covered and fixed to one end of the supporting body 11 and spaced apart from the diaphragm 2, and a plurality of protruding portions 32 formed by protruding and extending out of one side of the barrier plate body 31 close to the diaphragm 2. The plurality of protruding portions 32 are spaced apart. A distance between the protruding portions 32 and the diaphragm 2 is less than the maximum distance of the vibration displacement of the diaphragm 2 in the direction away from the barrier plate 3.

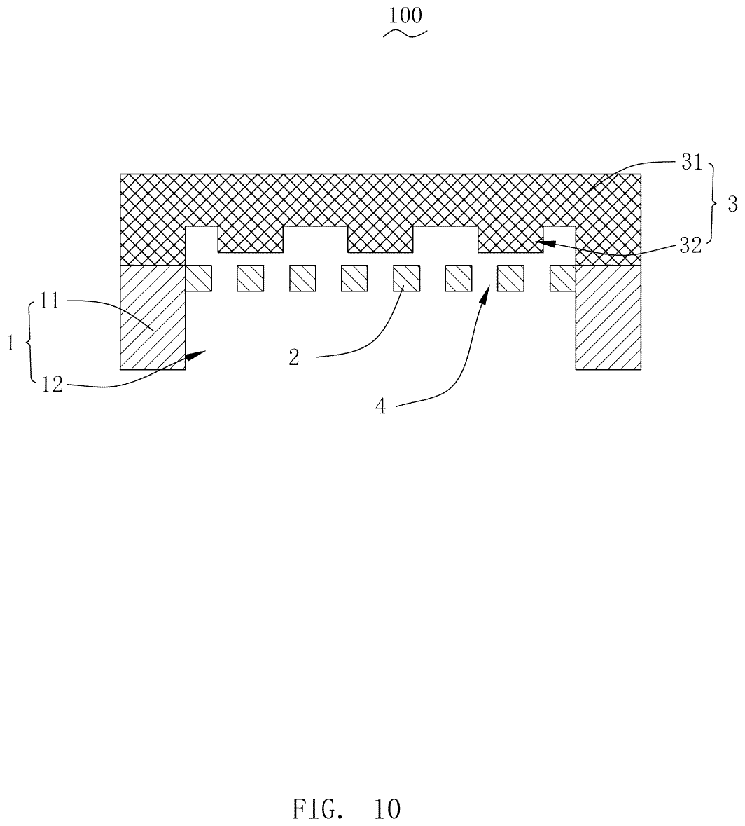

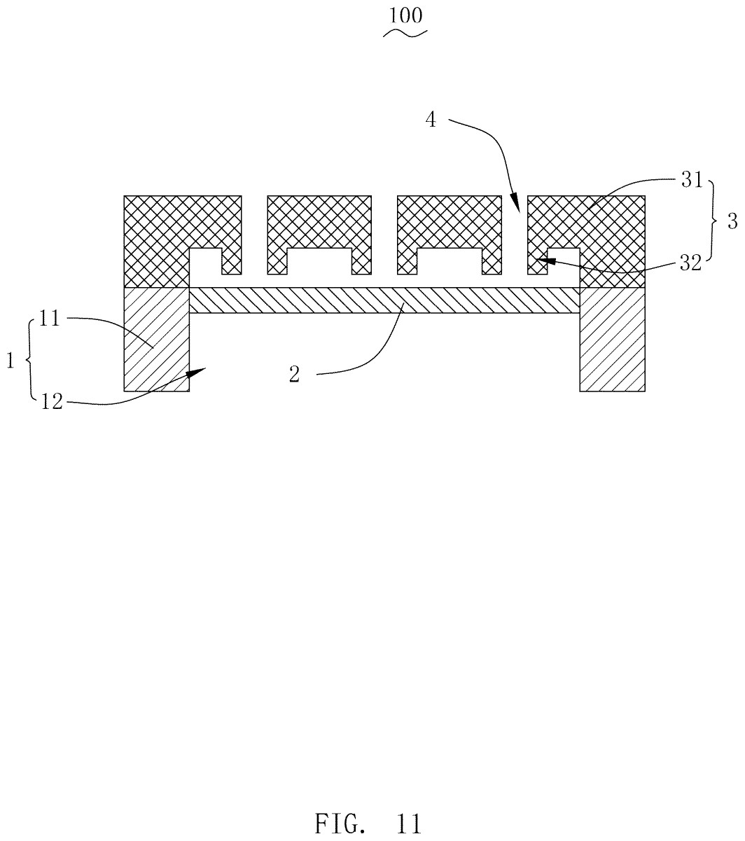

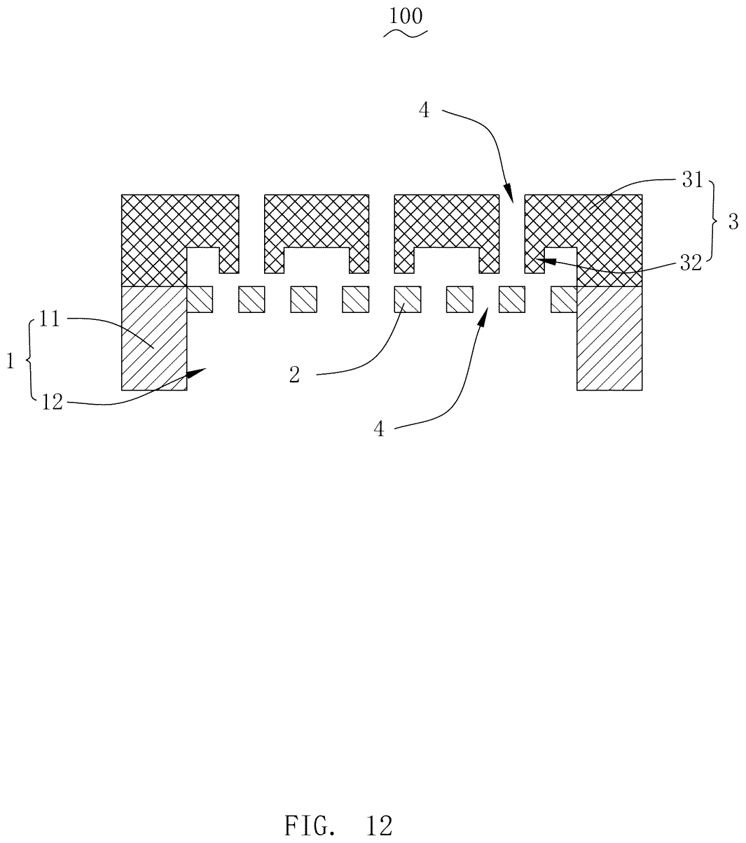

Based on this embodiment, to reduce the damping of the diaphragm 2 and enhance its vibration displacement effect, as shown in FIG. 10, in a first mode, a plurality of damping holes 4 penetrating through the diaphragm 2 are provided in the diaphragm 2 in a spacing manner in a vibration direction of the diaphragm 2. As shown in FIG. 11, in a second mode, a plurality of damping holes 4 penetrating through the diaphragm are provided in the barrier plate 3 in a spacing manner in a vibration direction of the diaphragm 2. As shown in FIG. 12, in a third mode, a plurality of damping holes 4 penetrating through the diaphragm 2 and the barrier plate 3 are respectively provided in the diaphragm 2 and the barrier plate 3 in a spacing manner in a vibration direction of the diaphragm 2.

The plurality of damping holes 4 are uniformly provided in the diaphragm 2; and the plurality of damping holes 4 are uniformly provided in the barrier plate 3. Of course, according to an actual need, the plurality of damping holes 4 in the diaphragm 2 can also be non-uniformly arranged, and the plurality of damping holes 4 in the barrier plate 3 can also be non-uniformly arranged.

At least a portion of the damping holes 4 in the diaphragm 2 and at least a portion of the damping holes 4 in the barrier plate 3 are staggered from each other.

The damping holes 4 in the barrier plate 3 are formed by penetrating through the protruding portions 32 of the barrier plate 3.

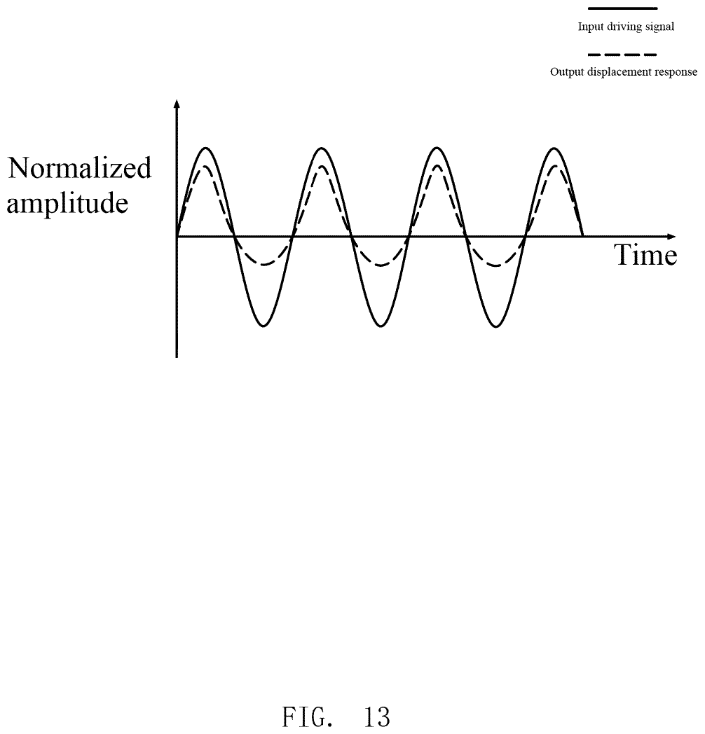

The supporting structure 1, the diaphragm 2, and the barrier plate 3 in the present invention are combined to form a nonlinear resonator. A response of the nonlinear resonator to an input signal is nonlinear, including but not limited to a displacement response belonging to an asymmetric amplitude. An input driving signal of the nonlinear resonator includes but is not limited to an amplitude-symmetric sine harmonic signal, an amplitude-asymmetric triangular wave signal, an amplitude-asymmetric square wave signal, or the like as shown in FIG. 13. An output displacement response of the nonlinear resonator includes but is not limited to an amplitude-asymmetric sine harmonic signal, an amplitude-asymmetric triangular wave signal, or an amplitude-asymmetric square wave signal, or the like as shown in FIG. 13.

The input signal of the nonlinear resonator in the present invention includes but is not limited to an ultrasonic signal modulated according to an amplitude of audible sound to human ears, and its formula is as follows:

$${u}_{0} = {U}_{0} sin ( 2 π {f}_{a} t ) sin ( 2 π {f}_{0} t ) ; or$$

$${u}_{0} = {U}_{0} ( sin ( 2 π {f}_{a} t ) + m ) sin ( 2 π {f}_{0} t ) .$$

Where u₀ represents an amplitude of driving voltage; U₀ represents the input signal of the nonlinear resonator; fₐ represents a frequency of the audible sound signal; f₀ represents a frequency of an ultrasonic carrier signal; and m represents a modulation coefficient.

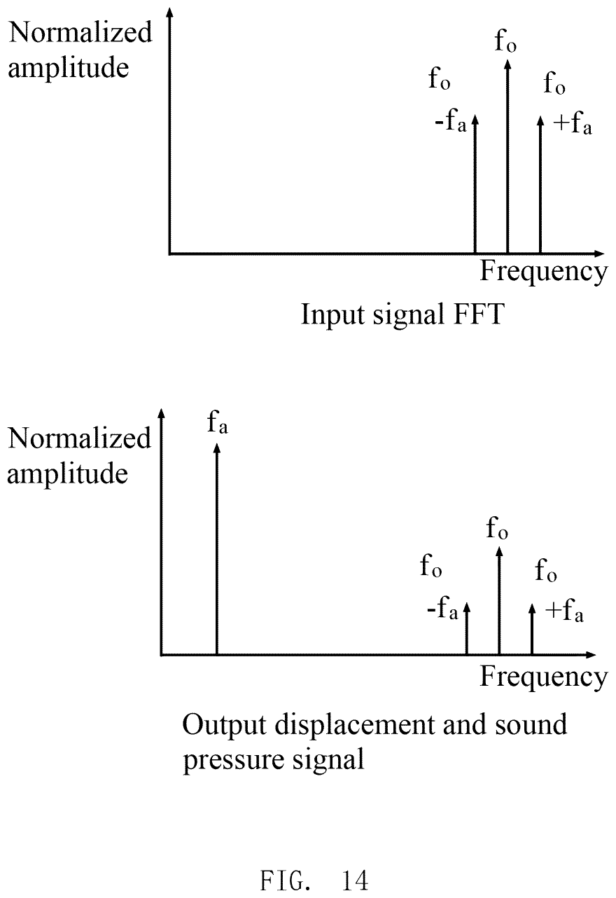

When the above ultrasonic modulation signal is input to the MEMS loudspeaker 100 in the present invention, the displacement response of the nonlinear resonator of the MEMS loudspeaker exhibits nonlinearity. A frequency spectrum of a frequency of audible sound can be obtained by analyzing the displacement response through fast fourier transform (FFT), as shown in FIG. 14.

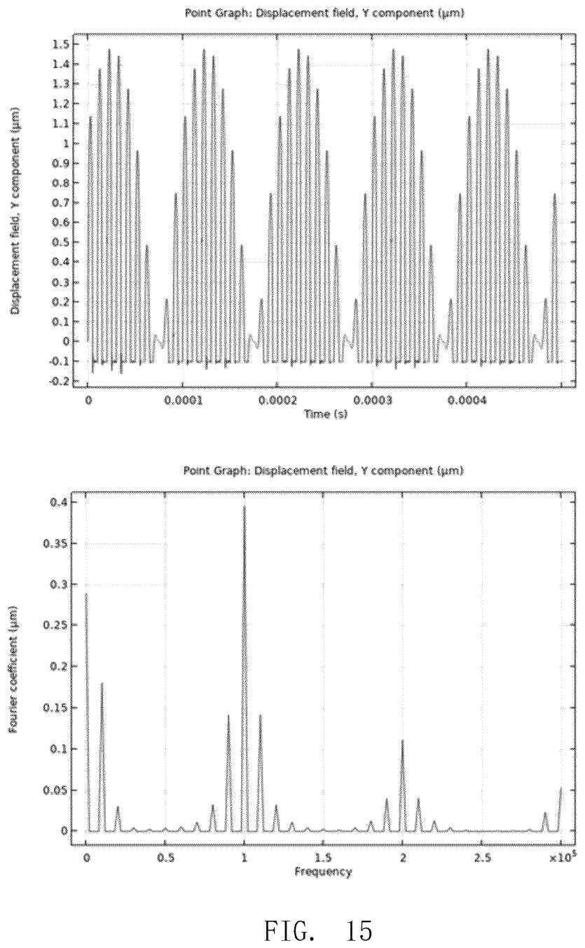

As shown in FIG. 15, it is evident that a displacement envelope curve is asymmetric (the negative displacement is suppressed).

A main function of the barrier plate 3 in the present invention is to restrict movement of the diaphragm 2 driven by an audible sound modulated ultrasonic signal. Namely, in a driving cycle, the maximum distance of the vibration displacement of the diaphragm 2 in the direction towards the barrier plate 3 due to the restriction of the barrier plate 3 is less than the maximum distance of the vibration displacement in the direction away from the barrier plate 3. The maximum distance of the vibration displacement of the diaphragm 2 in the direction towards the barrier plate 3 is set to A1. The maximum distance of the vibration displacement of the diaphragm 2 in the direction away from the barrier plate 3 is set to A2. The distance between the barrier plate 3 and the diaphragm 2 is set to g.

As shown in FIG. 1, the barrier plate 3 resists against the diaphragm 2, so that the barrier plate 3 can limit the vibration displacement of the diaphragm 2 in the direction towards the barrier plate 3. In this case, A1<A2=0.

As shown in FIG. 5, the barrier plate 3 is spaced apart from the diaphragm 2, and the distance between the barrier plate 3 and the diaphragm 2 is less than the maximum distance of the vibration displacement of the diaphragm 2 in the direction away from the barrier plate 3, so that the barrier plate 3 can also limit the vibration displacement of the diaphragm 2 in the direction towards the barrier plate 3. In this case, A1<A2=g.

As shown in FIG. 9, the barrier plate 3 includes the barrier plate body 31 covered and fixed to one end of the supporting body 11 and spaced apart from the diaphragm 2, and the plurality of protruding portions 32 formed by protruding and extending out of one side of the barrier plate body 31 close to the diaphragm 2. The plurality of protruding portions 32 are spaced apart. The distance between the protruding portions 32 and the diaphragm 2 is less than the maximum distance of the vibration displacement of the diaphragm 2 in the direction away from the barrier plate 3, so that the barrier plate 3 can also limit the vibration displacement of the diaphragm 2 in the direction towards the barrier plate 3. In this case, A1<A2=g.

According to the MEMS loudspeaker 100 of the present invention, the distance between the barrier plate 3 and the diaphragm 2 is less than the maximum distance of the vibration displacement of the diaphragm 2 in the direction away from the barrier plate 3; and due to the distance between the barrier plate 3 and the diaphragm 2, the amplitude-modulated ultrasonic waves can be demodulated to obtain the modulated sound waves, thereby improving the sound wave demodulation efficiency and amplitude of the MEMS loudspeaker 100 and further improving the acoustic performance of the MEMS loudspeaker 100.

The above is only the preferred embodiments of the present invention, and is not intended to limit the present invention. Any modifications, equivalent replacements and improvements that are made within the spirit and principle of the present invention shall fall within the protection scope of the present invention.

What is claimed is:

1. A micro-electromechanical system (MEMS) loudspeaker, comprising:
a supporting structure, wherein the supporting structure comprises a supporting body and a sound hole penetrating from one end of the supporting body to the other end;
a diaphragm, wherein the diaphragm is fixed on an inner circumferential side of the supporting body and located in the sound hole; the diaphragm is configured to vibrate and generate amplitude-modulated ultrasonic waves; and
a barrier plate, wherein the barrier plate is covered and fixed to one end of the supporting body; a distance between the barrier plate and the diaphragm is less than a maximum distance of vibration displacement of the diaphragm in a direction away from the barrier plate; and due to the distance between the barrier plate and the diaphragm, the amplitude-modulated ultrasonic waves are demodulated to obtain modulated sound waves.

2. The MEMS loudspeaker according to claim 1, wherein a plurality of damping holes penetrating through the diaphragm and/or the barrier plate are provided in the diaphragm and/or the barrier plate in a spacing manner in a vibration direction of the diaphragm.

3. The MEMS loudspeaker according to claim 2, wherein a plurality of damping holes penetrating through the diaphragm and the barrier plate are respectively provided in the diaphragm and the barrier plate; the plurality of damping holes are uniformly provided in the diaphragm; and the plurality of damping holes are uniformly provided in the barrier plate.

4. The MEMS loudspeaker according to claim 3, wherein at least a portion of the damping holes in the diaphragm and at least a portion of the damping holes in the barrier plate are staggered from each other.

5. The MEMS loudspeaker according to claim 1, wherein the barrier plate resists against the diaphragm.

6. The MEMS loudspeaker according to claim 1, wherein the barrier plate is spaced apart from the diaphragm.

7. The MEMS loudspeaker according to claim 1, wherein the barrier plate comprises a barrier plate body covered and fixed to one end of the supporting body and spaced apart from the diaphragm, and a plurality of protruding portions formed by protruding and extending out of one side of the barrier plate body close to the diaphragm; the plurality of protruding portions are spaced apart; and a distance between the protruding portions and the diaphragm is less than the maximum distance of the vibration displacement of the diaphragm in the direction away from the barrier plate.

8. The MEMS loudspeaker according to claim 1, wherein due to the distance between the barrier plate and the diaphragm, the barrier plate blocks an amplitude of vibration displacement of the diaphragm in a direction towards the barrier plate, so that the symmetric amplitude-modulated ultrasonic waves become asymmetric sound waves; and the asymmetric sound waves comprise the modulated sound waves.

9. The MEMS loudspeaker according to claim 1, wherein a driving mode for the diaphragm is any one of piezoelectric driving, electrostatic driving, and electromagnetic driving.

10. The MEMS loudspeaker according to claim 1, wherein the barrier plate is any one of a monocrystalline silicon barrier plate, a metal barrier plate, a polymer plate, and a multi-layer composite material barrier plate.
